(19) United States
(12) Patent Application Publication
(10) Pub. No.: US 2016/0182833 A1
(43) Pub. Date: Jun. 23, 2016

(54) Camera System for Cutting Table

(71) Applicant: SIGNAZON.COM, Dallas, TX (US)

(72) Inventor: Richard A. Debus, Dallas, TX (US)

(73) Assignee: SIGNAZON.COM, Dallas, TX (US)

(21) Appl. No.: 14/581,265

(22) Filed: Dec. 23, 2014

(51) Int. Cl. H04N 5/247; H04N 7/18; G05B 19/402; H04N 5/225

(52) U.S. Cl. CPC H04N 5/247; H04N 5/2253; H04N 7/181; G05B 19/402; G05B 2219/37555

(57) ABSTRACT

A camera system for digital and commercial cutting tables is described. The use of multiple cameras allows the cutting table to self-calibrate and perform cutting projects with minimal human interaction. One camera is placed near the surface of a cutting area. Another camera is placed higher above the cutting area, allowing it to see most of the cutting area. The higher camera can see when new media to be cut is placed on the cutting table. It can also find the location of any codes or guide dots on the media. The computer running the machine uses the higher camera to see new projects and then sends the lower camera for a close up view of codes and guide dots, allowing the machine to calibrate and begin a new project.

### TECHNICAL FIELD

The present disclosure is directed to the field of commercial and digital cutting, and more particularly to a computerized camera system for cutting tables.

### BACKGROUND OF THE INVENTION

Signage plays an important role in advertising. Companies, individuals, and various groups often need to print signs, mugs, magnets and other objects. These items can be for display at a store, a magnet for a car advertisement, giveaways, and other things. It is easy to print things on paper, but printing on other objects or in big sizes often requires specialized equipment.

Along with the difficulties of printing on various types, sizes and shapes of media is the difficulty of cutting that media. For example, a consumer may want a 4′×6′ sign on plastic. Not only will a special printer be needed but also a special cutter. The printer may stock 8′×20′ sheets of the desired plastic. A special printer can print the sign. After printing, there is a need for the most efficient possible means for cutting the sign from the larger plastic sheet. While at one time, this cutting may have been done by hand, there are now machines that can handle some of these tasks. But there is a need for a quicker, more efficient process with less reliance on human interaction. This would allow for quicker completion of cutting projects and lower costs.

There are several commercial cutting machines, sometimes called digital cutting tables, on the market. For example, the Kongsberg XP by Esko or the Graph-X-Cutter by MultiCam, Inc. These machines generally provide a large table surface with a rail system running along two opposing edges. The table surface is often movable, like a conveyor belt. An arm attaches to the rails on each edge and extends across the table surface holding a cutting tool and a camera. There may also be a vacuum attachment that pulls in shavings from the cutting process and disposes of them in a connected container. The cutting tool and camera are connected to a computer. As such, the cutting process can be computerized. A set of “cutting blueprints,” created especially for a given cutting project, can direct the computer how to cut a given sheet of plastic, paper, metal or other material. Various cutting attachments may be necessary for different cutting surfaces.

This system is not completely computerized because the machine has to know where to begin cutting and how the media is laid out angularly (i.e. the sheet position). Currently, a common solution to this problem is a code and dot system. A piece of media will contain one or more print projects, printed with a series of alignment “dots” and placed on the cutting table. An operator will position the camera over a QR code, bar code, or other code. The computer will read this code and match it to a “cutting blueprint”—that it previously stored. The operator will also have to position the camera over a predetermined alignment dot or dots printed on the media. The computer, with the camera, will read these dots, allowing the machine to calibrate its position in the xy plane. The machine is then ready for cutting and can proceed without human interaction.

Although it's great to have a cutter that, once positioned correctly, can proceed without human interaction, it would be better to reduce, minimize, or even eliminate human interaction. It would be desirable to have an operator place a cutting project on the table surface, in any directional orientation, and walk away. It would be desirable to have the machine complete a printing process, slide a finished project down the table or into a receiving area, and move automatically to the next project. An operator could simply be needed to place new cutting projects on the cutting table. The machine could calibrate itself, read what projects are in the queue, load the “cutting blueprints” and complete cutting projects without further human interaction.

Digital cutting tables can be dangerous. The cutting tools are sharp, and if the machine is self-directed then it needs some form of safety cutoff mechanism. Some type of safety feature is needed such that if a person or object falls into the cutting path then the machine will turn off.

### BRIEF SUMMARY OF THE INVENTION

One embodiment of the invention is a cutting machine. The embodiment comprises a work area, also referred to as a surface area, and an arm extending over the work area and able to slide along the length of the surface area. The machine further comprises a first camera, attached to the arm and able to slide along the length of the arm and a cutting tool, also attached to the arm and able to slide along the arm. The machine further comprises a second camera positioned above the work area and able to see substantially all of the surface area. There is a microprocessor in communication with each of these parts and able to control their movements.

Another embodiment of the invention is a cutting machine comprising a camera placed above a surface area and able to view substantially all of the surface area. A microprocessor is in communication with the camera and can use the camera to determine when a new cutting project is on the surface area. The microprocessor can use the camera to locate positional and identification markings on the cutting project.

Another embodiment of the invention is a method for calibrating a cutting machine. The method comprises: placing a first camera above a cutting area, the camera pointed generally downward and coupled to a microprocessor; placing a second camera above the cutting area and higher than the first camera, the second camera pointed generally downward and able to view substantially all of the cutting area, the second camera further coupled to the microprocessor; using the second camera to identify when a new cutting project is located on the cutting area and to find the general location of informational guides on the media; and moving the first camera to the general location of the informational guides and capturing images of the information guides for use by the microprocessor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of a prior art cutting machine;

FIG. 2 is an embodiment of a cutting sheet for use with the current invention;

FIG. 3 is a perspective of an embodiment of a cutting machine in accordance with the current invention;

FIG. 4 is a perspective view of a cutting machine in the current invention with multiple cutting projects;

FIG. 5 is a flow-chart diagram of a method according to an embodiment of the invention; and

FIG. 6 is a flow-chart diagram of a method according to an embodiment of the invention.

### DETAILED DESCRIPTION OF THE INVENTION

The invention comprises an improved digital cutting table and camera system. Many of the embodiments will work as a semi-automated CNC (computer numerical control) vision system. Embodiments of the invention can comprise an entire cutting table or may comprise an aftermarket add-on to an already existing cutting apparatus.

The printing industry uses numerous automated printers and cutters. But there is still a lot of human interaction needed to adjust settings and positions of a machine, a cutter, or the media to be printed upon or cut. Cutting is particularly in need of technologies that can automate various tasks. Several digital cutting machines already exist, such as the Kongsberg XP by Esko or the Graph-X-Cutter by MultiCam, Inc. These machines can cut media automatically by using cutting blueprints encoded in a computer. However, the machines need human help to locate a code (usually QR or barcode) identifying the cutting project so that a connected computer can access the appropriate cutting blueprints. Furthermore, the machine needs a human to help it determine the sheet position in the xy plane and to locate a “first dot” to begin the cutting process. Knowing its exact location with respect to the media allows the machine to cut in the appropriate directions and distances.

These digital cutting tables are very helpful to the printing industry. But there is a need for an even smarter digital cutting table that allows less human interaction. It would be great if a cutting table could automatically analyze media for a cutting project, calibrate itself, complete the cutting, and move on to the next project.

The present invention helps to solve these problems by placing a camera above the cutting table. This position camera will be placed such that it will be able to view the entire cutting surface. The position camera can view multiple cutting projects (pieces of media to be cut) laid out on the cutting table. In contrast, the cutting camera, also used in the prior art, is located close to the table surface, adjacent to the cutting element. The cutting camera can be used to view smaller information such as bar codes, QR codes, and guide dots for cutting. In the invention, both the position camera and the cutting camera will be communicatively coupled to a computer that controls the cutting machine. As detailed further below, the position camera can see a cutting project on the table and direct the cutting camera and the cutter to complete the cutting project.

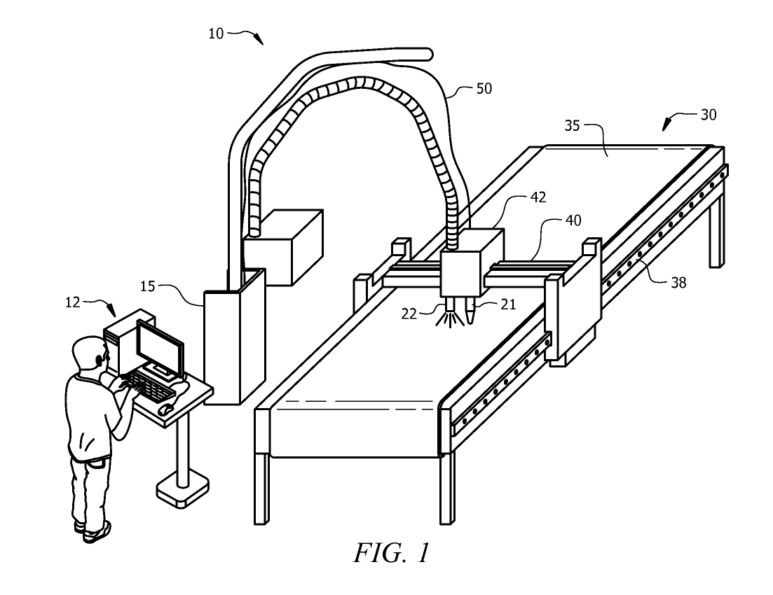

Referring now to FIG. 1, a prior art cutting machine 10 is shown. The cutting machine 10 comprises a cutting table 30 with a conveyor surface 35. An arm 40 extends over the work area, or surface 35. A cutting platform 42 is attached to the arm 40 and can slidably move along the length of the arm 40. Furthermore, arm 40 can slidably move along the length of the table. Cutting platform 42 can therefore reach any point on the surface 35. Attached to the cutting platform 42 are a cutting camera 22 and a cutter 21. A vacuum hose 50 is attached to the cutting platform 42 and pulls away cutting debris and deposits it into a receptacle 15. Computer 12 controls the machine 10. Computer 12 will have information for various cutting projects stored in its memory or hard drive. The cutting blueprints (the exact path the cutter must take and the measurements and directions) of a given project are stored on the computer 12 and are identified with a code that is printed on the media to be cut. The cutting camera 22 will need to be placed over a certain set of dots next to the code, or over the code itself. The computer 12, with the cutting camera 22, reads the code, identifies the cutting project and loads the instructions. The operator then moves the cutting camera over a dot designated the “first dot.” Once the camera has located the first dot the computer can then direct the cutter 21 to complete the project according to the blueprints. When an operator has a new cutting project he will again have to place the cutting camera 22 in a certain location over the media so the computer 12 can read the code and identify the cutting project and then located the first dot.

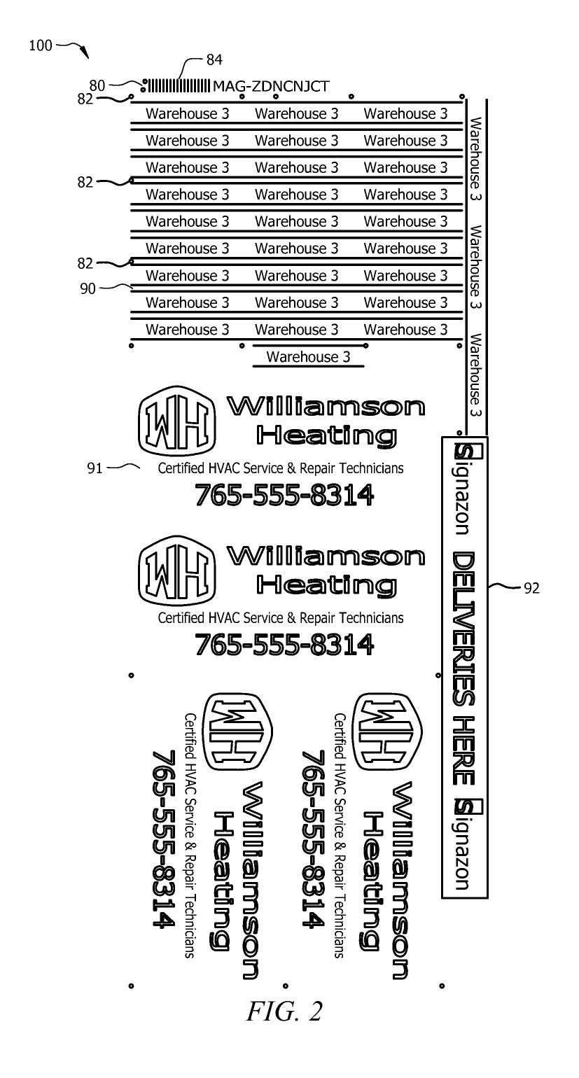

A typical cutting project sheet 100 is shown in FIG. 2. Sheet 100 could be a typical cutting project in the prior art but also for use with embodiments of the present invention. Sheet 100 features various signage 90, 91, and 92 to be cut. Signage 90, 91, 92 could be intended for advertising signs, car magnets, posters or other things. Sheet 100 comprises a plurality of dots 82. The dots can be seen by a cutting camera, allowing the camera to locate itself in relation to the sheet 100. Guide dots 80 are often placed next to code 84. An operator will place a cutting camera over the guide dots 80. The computer will recognize the guide dots 80 and scroll right to read code 84. Code 84 will identify the cutting project. The computer can then load the blueprints for the particular cutting project and begin cutting. The guide dots 80 and other dots 82 can be used by the computer and cutting camera to orient the cutting process. Although the cutting machines available currently afford users a great range of capabilities, there is still a lot of human interaction needed to direct the cutting process. The process of orienting the cutting camera appropriately over the cutting project can be time consuming.

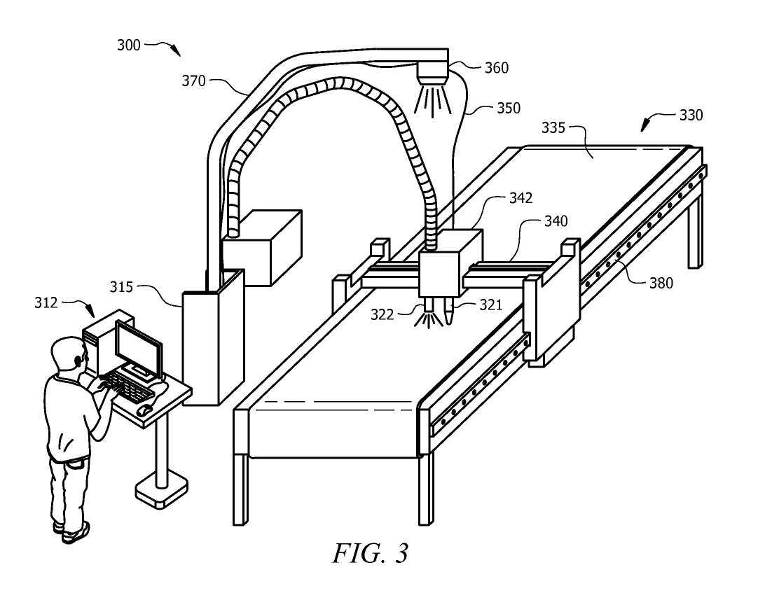

Referring now to FIG. 3, an embodiment of the invention is shown. FIG. 3 shows cutting machine 300 comprising a cutting table 330, arm 340, and computer 312. Position camera 360 is extended above the table 330 by camera mount arm 370. Table 330 has a track system 380 along each longitudinal edge. Arm 340 attaches to the track system 380 on each side and extends across the table supporting central unit 342. The track system 380 allows the arm 340 to slide along the length of table 330. Central unit 342 comprises a cutting camera 322 and a cutter 321. Central unit 342 can slide along the arm 340. Cutter 321 is therefore capable of reaching virtually any point on table 330. The surface 335 of table 330 in this embodiment has a conveyor belt type construction such that it will move slidably along table 330. A vacuum 350 pulls away cutting debris and deposits it in a receptacle 315. Computer 312 controls the machine 300.

Referring to FIG. 3, with continuing reference to FIG. 2, the capabilities of cutting machine 300 can be described. In the prior art an operator would place sheet 100 on table 330 and then line up the cutting camera over guide dots 80 and code 84 and help the machine to calibrate and orient itself with respect to sheet 100. With the invention however, the operator places sheet 100 on table 330 and walks away. Position camera 360 can be set to automatically recognize when a new sheet 100 is placed on the table 330. The computer 312, using the position camera 360, will search sheet 100 for guide dots 80 and/or code 84. If these cannot be found the computer 312 can tell arm 340 to move and uncover any area that was hidden from position camera 360. Once the guide dots 80 or code 84 are found the computer can move the arm 340 and central unit 342 so that cutting camera 322 can read guide dots 80 and code 84. Position camera may be able to read the dots 80, 82 by itself and even potentially the code 84. Computer 312 will then load the blueprints associated with code 84, calibrate and orient the machine 300 and begin cutting. The computer 312 will direct the cutter 321 along sheet 100 to cut out signage 90, 91, and 92. The cutter 321 can therefore complete the cutting project without further human interaction. Surface 335 can be a conveyor belt and can also move the sheet 100 along table 330. The cutting camera 322 can be used to intermittently or continuously look for further dots 82 on sheet 100. This can provide ongoing calibration and quality control during the cutting process.

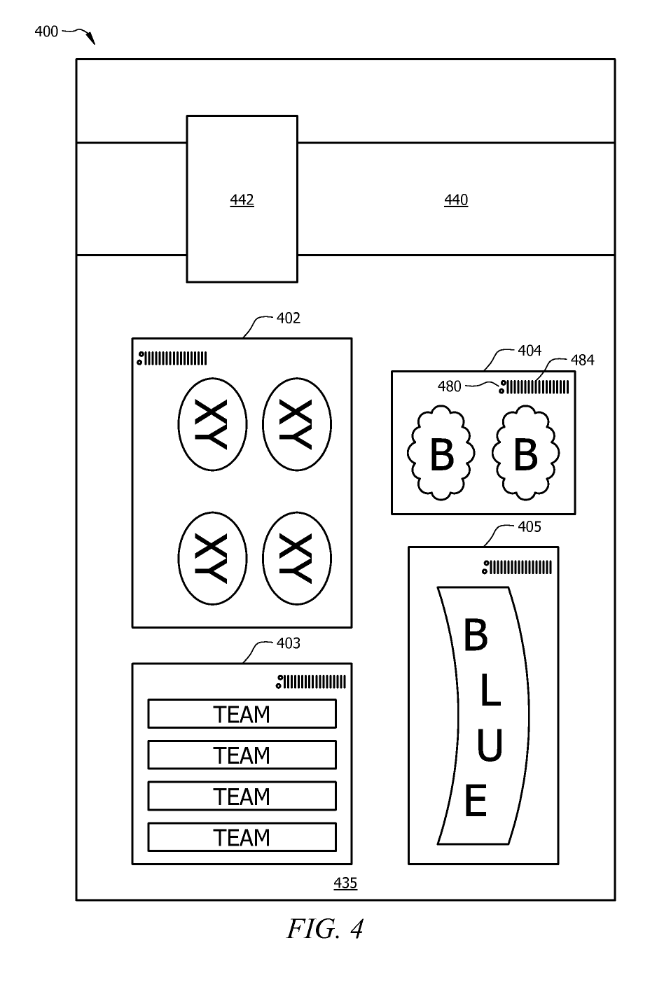

FIG. 4, with continuing reference to FIGS. 2 and 3, shows how multiple projects can be placed on a cutting table 400 according to the invention. Under the prior art a human operator would have to calibrate and load each of these cutting projects into the machine 400. However, under the invention the position camera 360 sees each sheet 402, 403, 404, and 405. The computer 312 uses the position camera 360 to located each sheet 402, 403, 404 and 405 and their approximate locations. The position camera 360 can also locate the guide dots 480 and code 484 for each sheet 402, 403, 404 and 405. The position camera 360 may not be able to read the code 484. If needed, the computer 312 will send the cutting camera to read guide dots 480 and code 484. The position camera 360, guided by the computer 312 can also locate the first dot. The first dot may be different for each project and may be identified in the blueprints for a cutting project. The computer 312 can use position camera 360 to find the general location of the first dot and then send cutting camera to view the first dot up close. The cutting camera 322 will often start at the first dot and then move to a second dot whose location is part of the blueprints. This helps the machine 300 ensure that cutter 321 is located properly on the cutting project. As shown in FIG. 4, an operator can place multiple projects on the cutting table 400 and allow the cutter to finish the jobs without further adjustment.

The computer 312 in FIG. 3 can take a variety of forms. It will often be an integrated part of the cutting machine 300. Although it could also be a separate device that attaches to machine 300 and can be loaded with software to manage machine 300. In some embodiments computer 312 can be a PC or other commercially available computer system. In some embodiments computer 312 will comprise a keyboard, a screen, a mouse, a hard drive, a processor, and memory. A variety of configurations are possible. In some embodiments the computer 312 will utilize a touch screen or may take the form of a tablet computer. Computer 312 will have access to blueprints for various cutting projects. These blueprints may be stored locally on a hard drive or memory. Alternatively, computer 312 can have a network connection to a database or another computer that stores project blueprints. Computer 312 will have software and/or hardware capable of controlling the various parts of cutting machine 300 and loading associated blueprints. Computer 312, via software or hardware, knows the location of arm 340, central unit 342, cutting camera 322, cutter 321, and position camera 360. Other data possibly needed by computer 312 would be the dimensions of the table 330 and surface 335, and the height and location of the cutting camera 322, table 330, and position camera 360. Knowing these locations allows the computer 312 to take cutting blueprints and adapt them to the exact layout of the cutting machine 300.

The cutting camera 322 of FIG. 3 can be attached or integrated into the central unit 342. In most embodiments the cutting camera will be a digital camera of fewer megapixels than the position camera 360. For example, cutting camera 322 may be a 1 MP digital camera. A variety of configurations are possible. Cutting camera 322 will be connected to the computer 312. This allows the cutting camera 322 to send images to the computer 312 for analysis. For example, the cutting camera 322 will capture a QR code and send it to the computer 312 for processing. The computer 312 can monitor the images captured by the cutting camera 322 as it moves over surface 335 of table 330. When the computer 312 sees certain codes or dots or series of dots, via the cutting camera 322, it can process that information. The cutting camera 322 can accomplish a variety of tasks: code reading, edge detection, sheet position and more.

Position camera 360 of FIG. 3 can be located sufficiently above table 330 such that it can view the entire surface 335. Generally position camera 360 will be of a larger resolution than cutting camera 322. For example, in a typical embodiment cutting camera 322 will be a 1 MP digital camera and position camera 360 will be a 16 MP digital camera. But a variety of configurations of cameras and camera resolution are available. Position camera 360 will be connected to the computer 312 so that computer 312 can receive and analyze the images captured by position camera 360. The position camera 360 will generally be placed a distance above table 330 and surface 335. It can be directly overhead or at a variety of angles as long as it can see the entire surface 335 and any cutting projects placed on it. Camera mount arm 370 can hold and support position camera 360 above table 330. Camera mount arm 370 will likely also support the tube for vacuum 350. Other configurations are possible. For example, position camera 360 can be incorporated into a ceiling or some other fixture. Position camera 360 can accomplish a variety of tasks: safety zone detection (discussed below), edge detection, sheet position and more.

Cutter 321 is attached or integrated into central unit 342. A variety of cutter configurations are possible and are well known in the prior art. Some cutters are made from steel or a variety of metals and alloys. Laser and plasma cutters are also available and usable with the invention.

Central unit 342 houses or supports cutter 321, vacuum 350, and cutting camera 322. Central unit 342 attaches to arm 340 and is slidable along the length of arm 340. Central unit 342 may move along a track system integrated into arm 340. A variety of movement mechanisms are compatible with the invention. Computer 312 is in communication with central unit 342 and can direct its movements.

Arm 340 of FIG. 3 attaches to the sides of table 330 and supports central unit 342. Arm 340 can move along the length of table 330 by means of a track system 380. A variety of sliding mechanisms are compatible of allowing arm 340 to move along table 330. Arm 340 is in communication with computer 312 and computer 312 directs its movements. It will generally be preferable for arm 340 to connect to a track system 380 on the sides of table 330. A track system 380 on the edge of the top of table 330 will tend to detract from the available cutting space on surface 335. But such configurations are possible.

FIG. 2 shows an embodiment of dots 82, guide dots 80 and code 84. In the prior art guide dots 80 are often place directly to the left of code 84. This layout indicates to the computer 312 to begin calibrating and reading information. The computer 312 can then direct cutting camera to move over code 84 and transmit images of code 84. Dots 82 can be located at various locations over sheet 100. Guide dots 80 and dots 82 can take a variety of forms. Their pattern can be set by users. What's important is that the computer 312 know how to read the dots and for what purpose. Generally, dots will be used to calibrate the machine 300 for a given cutting project on a sheet 100. Code 84 can be a QR code, a bar code, or a variety of other symbols or codes. The purpose is to identify a cutting project so the computer 312 can access the associated cutting blueprints.

Another embodiment of the invention allows the position camera 360 to identify the cutting project by itself, either from reading a code 84 by itself, or by recognizing the shape of the media. The computer 312 would then load and read the instructions for the project. Then the computer 312 could move the cutting camera 322 over the first dot to calibrate and begin the cutting process.

In some embodiments with a powerful position camera 360 there may be no need for one or more of the cutting camera 322, dots 82, guide dots 80, or code 84. In such embodiments the position camera will be strong enough to read code 84 or dots 80 or 82 from its position, without the help of cutting camera 322. And in some embodiments the position camera 360, because it can see a sheet or piece of media in great detail, can automatically recognize a cutting project on a sheet and automatically access the associated cutting blueprints. The computer 312 would then be able to calibrate and situate the cutter 321 and begin and complete the cutting process.

One use of the current invention is for safety purposes. There is a danger that a person or an object will fall on the table 330 and be damaged or hurt by the cutter 321. Some current cutting machines comprise an optical or laser sensor that sense when an object comes near the arm 340. Position camera 360 provides a more advantageous solution. Position camera 360 can see the entire table 330. Computer 312 can continuously analyze the images from position camera 360 and determine if a foreign object is on the table or in a dangerous position. Computer 312 can turn off the cutter 321, move central unit 342, slow down cutter 321, pause cutter 321, or take another precautionary step as necessary.

The cutting machine 300 and position camera 360 of the invention can be produced as an integrated whole. There are further embodiments wherein a prior art machine, such as machine 10 in FIG. 1, can be retrofitted with a position camera 360 and updated software to allow a legacy device to achieve increased capabilities.

The cutting machine 300 of FIG. 3 is semi automatic in that an operator must load and unload cutting sheets onto surface 335. However there are embodiments in which automatic loaders and unloaders create a fully automated process. An automatic loader would pick up sheets from stock or a given location and load them onto surface 335. The position camera would automatically see the new sheet and begin working on it. Afterwards an unloader could pick up the finish product and/or any waste material and deposit them in chosen locations.

The invention is compatible with cutting various kinds of media. Metal, plastic, paper, cardboard, poster board and other materials can be cut. Some embodiments can deal with cutting more 3-dimensional shapes.

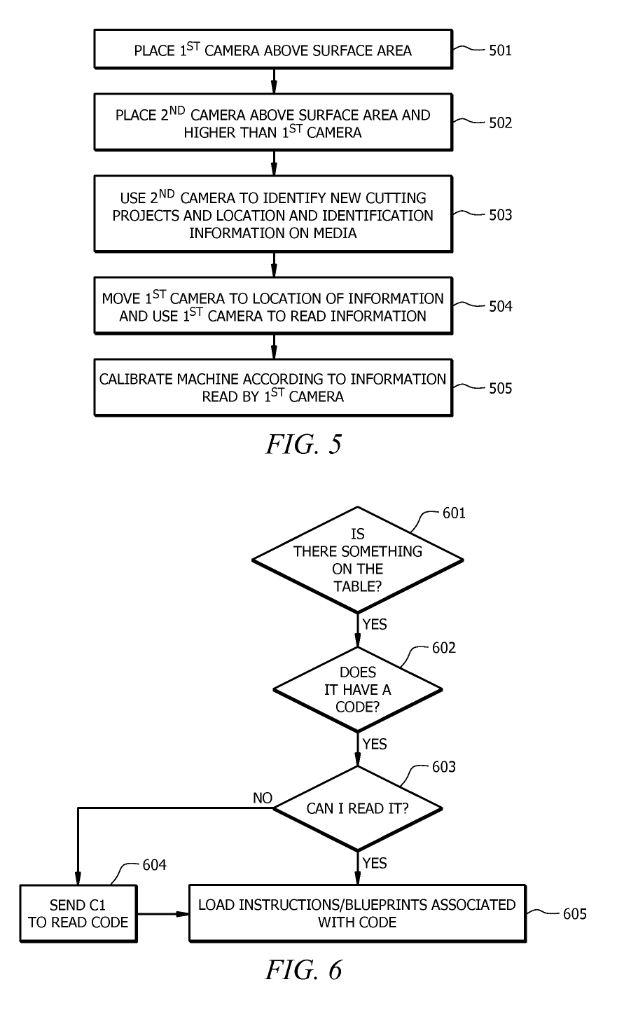

FIG. 5 shows an embodiment of a method for calibrating a cutting machine according to the invention. First, at 501, the cutting camera is placed above a surface or cutting area. Then, at 502, a position camera is placed over the surface area, higher than the first camera and able to see substantially all of the surface area. Third, at 503, the position camera is used to identify when new cutting projects are on the surface area. At 504, the microprocessor running the machine moves the cutting camera to the location of any codes or guide dots on the cutting project. Finally, 505, the machine uses the information captured by the cutting camera to calibrate the machine and begin the cutting project.

FIG. 6. shows an embodiment of a method according to the current invention. This method is an embodiment of the process a microprocessor goes through to deal with new cutting projects. First 601 the microprocessor figures out if there is something on the cutting table. Second 602 the microprocessor looks to see if there is a code on the object. Then 603 the microprocessor figures out if it can read whatever code it finds using the position camera. If not, then 604 the microprocessor sends the cutting camera to look at the code. If the position camera can read the code, then it 605 begins loading instructions and blueprints from the identified project. Similarly, if the cutting camera reads the code, then 605 the microprocessor loads instructions and blueprints from the project.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An automated cutting table system comprising:
a work area;
an arm, the arm extending over the work area and able to slide along an edge of the work area;
a first camera mounted on a cutting platform, the cutting platform attached to the arm and able to slide along the length of the arm such that the first camera is able to view an adjacent section of the work area;
a cutting tool mounted on the cutting platform, wherein movement of the cutting platform allows the cutting tool to move over the work area;
a second camera, the second camera positioned over the work area and able to view substantially all of the work area;
a microprocessor, the microprocessor in communication with the first and second cameras, the arm, and the cutting tool and able to direct the movements of same, wherein data from the second camera allows the microprocessor to position the first camera and cutting tool over a chosen segment of the work area.

2. The system of claim 1, further comprising a conveyor belt on the surface area.

3. The system of claim 1, wherein the second camera is a digital camera of at least 16 megapixels.

4. The system of claim 1, further comprising a vacuum tube, the vacuum tube operable to pull debris away from the surface area.

5. The system of claim 1, further comprising a camera mount arm to support the second camera.

6. The system of claim 1, further comprising a track system along the edges of the table operable to allow the arm to move along the length of the table.

7. The system of claim 1, wherein the cutting tool comprises a laser cutter.

8. The system of claim 1, wherein the cutting tool comprises a plasma cutter.

9. The system of claim 1, wherein the cutting tool comprises a metal edge.

10. The system of claim 1, the second camera further operable to turn off the machine when a foreign object is on the cutting area.

11. A cutting table for cutting elements out of a sheet of media, the sheet of media including markings to identify a job associated with the sheet of media, markings indicating the initial cut point, and markings used as reference points, the cutting table comprising:
a work surface, the work surface holding the sheet of media to be cut;
a cutting element mounted on a platform movable over the work surface;
a camera placed above the surface area and able to view substantially all of the surface area;
a microprocessor in communication with the camera and operable to use the camera to control the location of the platform, the microprocessor further operable to use the camera to locate positional and identification markings on the piece of media.

12. The cutting table of claim 11, further comprising a conveyor belt on the surface area.

13. The cutting table of claim 11, wherein the camera is a digital camera of at least 16 megapixels.

14. The cutting table of claim 11, further comprising a vacuum tube, the vacuum tube operable to pull debris away from the surface area.

15. The cutting table of claim 11, further comprising a camera mount arm to support the camera.

16. The cutting table of claim 11, further comprising a user interface comprising a keyboard and mouse.

17. The cutting table of claim 11, further comprising a laser cutter.

18. The cutting table of claim 11, further comprising a plasma cutter.

19. The cutting table of claim 11, further comprising a metal cutting tool.

20. The cutting table of claim 11, the camera further operable to turn off the machine when a foreign object is on the surface area.

21. A method for calibrating a cutting machine, comprising:
placing a first camera above a cutting area, the camera pointed generally downward and coupled to a microprocessor, the first camera associated with a moveable platform and cutting element;
placing a second camera above the cutting area and higher than the first camera, the second camera pointed generally downward and able to view substantially all of the cutting area, the second camera further coupled to the microprocessor;
using the second camera to identify when a new cutting project is located on the cutting area and to find the general location of informational guides on the media; and
moving the first camera to the general location of the informational guides based on information from the second camera and capturing images of the information guides for use by the microprocessor.

22. The method of claim 21, further comprising using a conveyor belt to move cutting projects on the cutting area.

23. The method of claim 21, further comprising using an automatic loader to load cutting projects onto the cutting area.

24. The method of claim 21, further comprising using an automatic unloader to unload cutting projects from the cutting area.

25. The method of claim 21, further comprising placing a vacuum tube near the cutting area to remove debris.
